(19) United States
(12) Patent Application Publication
(10) Pub. No.: US 2009/0154138 A1
(43) Pub. Date: Jun. 18, 2009

(54) LIGHTING DEVICE FOR OPERATION PANEL AND ELECTRONIC DEVICE

(76) Inventors: Hiroto Isoda, Fujiyoshida-shi (JP); Kenji KUSANO, Yamanashi-ken (JP); Tatsuro YAMADA, Fujiyoshida-shi (JP)

Correspondence Address: BRINKS HOFER GILSON & LIONE, P.O. BOX 10395, CHICAGO, IL, 60610, US

(21) Appl. No.: 12/332,532

(22) Filed: Dec. 11, 2008

(30) Foreign Application Priority Data
Dec. 12, 2007 (JP) JP2007-320881

(51) Int. Cl. G09F 13/04

(52) U.S. Cl. 362/97.1

(57) ABSTRACT

A lighting device illuminates an operation panel having a plurality of display area groups (2A, 2B) each including at least one display area. The lighting device can illuminate the operation panel with different light for each display area group. The lighting device includes at least two sheet-shaped lightguide members (4A, 4B) corresponding to the plurality of display area groups, respectively. The lightguide members are stacked at a back of the operation panel. The lighting device further includes light sources (5A, 5B) that are disposed to face at least one edge of the respective sheet-shaped lightguide members each guiding light from the respective light sources. The lightguide members (4A, 4B) have respective light-emitting areas (8) that deflect and emit the guided light toward the display areas of the corresponding groups (2A, 2B).

### RELATED APPLICATIONS

This application claims priority under 35 U.S.C. §119 to Japanese Patent application No. JP2007-320881 filed on Dec. 12, 2007, the entire contents of which are hereby incorporated by reference.

### TECHNICAL FIELD

The present invention relates to a lighting device used in an electronic device such as a mobile phone to illuminate its operation keys from the back thereof.

### RELATED ART

A plurality of operation keys are used in electronic devices such as mobile phones, personal digital assistants (PDAs), mobile personal computers (PCs), and mobile game consoles. To facilitate key input operations in dark places, these electronic devices employ a lighting device for operation keys that illuminates the keys by applying light from the back thereof, for example.

For example, Japanese Patent Application Publication No. 2001-167655 proposes a lighting device for pushbutton switches that includes a plurality of operation keys provided on a keypad or a key panel, a substrate having a plurality of switching elements disposed underneath the key panel, and a pliable lightguide plate disposed between the key panel and the substrate to apply, toward the key panel, light from a light-emitting diode (LED) light source that enters the lightguide plate through a side edge surface thereof.

Conventionally, electronic devices, such as mobile phones, are designed to enable a minimal number of operation keys to be used in various ways. For example, in many electronic devices, the number-key function and the letter-key function are assigned to the same key, and the two functions are selectively used by switching therebetween. Regarding such operation keys, each key has two different display areas, i.e. number display area, and letter display area, and it is desired to selectively light up these display areas. However, it has been difficult with the conventional lighting technique to selectively light up the different display areas, i.e. number and letter display areas, because the whole operation panel is illuminated from below with a single lightguide plate. It is possible to individually light up the number display area and the letter display area by directly illuminating them with an LED light source provided for each display area of the operation keys without using a lightguide plate. In this case, however, the number of LED light sources installed in a device increases, resulting in an increase in the parts cost. There is another problem that because the directivity of LEDs is narrow, light enters only a part of each operation key and it is difficult to light up the operation keys uniformly.

### SUMMARY OF THE INVENTION

The present invention has been made in view of the above-described problems with the related art. Accordingly, an object of the present invention is to provide a lighting device capable of individually lighting up a plurality of display areas of operation keys on an operation panel with a minimal increase in the parts cost. Another object of the present invention is to provide an electronic device having the lighting device of the present invention.

The present invention provides a lighting device that illuminates an operation panel from the back thereof. The operation panel has a plurality of operation keys arranged in a plane thereon. The operation keys each have at least one display area capable of transmitting light. The display areas on the operation panel are divided into a plurality of groups, each having at least one display area. The lighting device includes at least two sheet-shaped lightguide members, the number of the sheet-shaped lightguide members corresponding to the number of the plurality of groups, respectively. The sheet-shaped lightguide members are stacked at the back of the operation panel. The lighting device further includes at least one light source provided at at least one side edge of each of the sheet-shaped lightguide members to emit light into the each lightguide member through the side edge and the light is guided or transmitted in the each lightguide member. Each sheet-shaped lightguide member has at least one light-emitting area that deflects and emits the guided light toward the at least one display area of the corresponding group.

In this lighting device, the display areas divided into groups on the operation panel are illuminated with respective lights from the sheet-shaped lightguide members corresponding to the display area groups. Accordingly, the display areas can be lit up with light of different colors for each group and can be selectively lit up for each group.

Specifically, the at least one light-emitting area of each sheet-shaped lightguide member may be provided at a position that faces the at least one display area of the corresponding group in the stacking direction of the sheet-shaped lightguide members.

At least two of the groups may share at least one display area with each other. With this arrangement, the shared at least one display area is illuminated with two lights from the sheet-shaped lightguide members corresponding to the at least two groups and hence can be lit up with color-mixed light.

The lighting device may further include at least one sheet-shaped light shield member disposed between mutually adjacent ones of the sheet-shaped lightguide members. The each sheet-shaped light shield member has at least one light-transmitting area that is a passage of light toward the at least one display area, the light being emitted from the light-emitting area of any of the sheet-shaped lightguide members that are disposed more away from the operation panel than the each sheet-shaped light shield member. A sheet-shaped light shield member interposed between mutually adjacent ones of the sheet-shaped lightguide members prevents the mutually adjacent sheet-shaped lightguide members from contacting each other, and thus, lights from the lightguide members are prevented from mixing together undesirably. Thus, it is possible to ensure a clear color distinction between different groups of display areas.

Specifically, the light-emitting area may be designed to deflect the guided light by reflection and scattering.

The plurality of light sources may be arranged to have different colors of emission for each of the lightguide members and the respective light sources face at at least one respective edges of the lightguide members

Specifically, the plurality of light sources may include a red light source, a green light source, and a blue light source.

Properly mixing these three primary colors makes it possible to light up the display areas with various colors of light.

In addition, the present invention provides an electronic device including an operation panel having a plurality of operation keys arranged thereon. Each operation key has at least one display area to transmit light. The display areas on the operation panel are divided into a plurality of groups. The electronic device further includes the above-described lighting device and a switching part disposed at a side of the stacked sheet-shaped lightguide members of the lighting device that is opposite to the operation panel. The switching part has switching elements disposed to correspond to the operation keys, respectively.

With this electronic device, the display areas can be displayed in a plurality of colors. Accordingly, the electronic device can be improved in operability and design.

### BRIEF DESCRIPTION OF THE DRAWINGS

FIG. 1 is an exploded perspective view of a first embodiment of a lighting device according to the present invention that is used for an operation panel.

FIG. 2 is a plan view of the operation panel shown in FIG. 1.

FIG. 3 is a schematic exploded perspective view of a mobile phone (electronic device) equipped with the lighting device shown in FIG. 1.

FIG. 4 is a plan view of an operation panel illuminated by a lighting device according to a second embodiment of the present invention.

FIG. 5 is an exploded perspective view of a lighting device according to the second embodiment.

FIG. 6 is a side view of the lighting device in FIG. 5 and the operation panel illuminated by the lighting device.

### DETAILED DESCRIPTION OF THE PREFERRED EMBODIMENTS

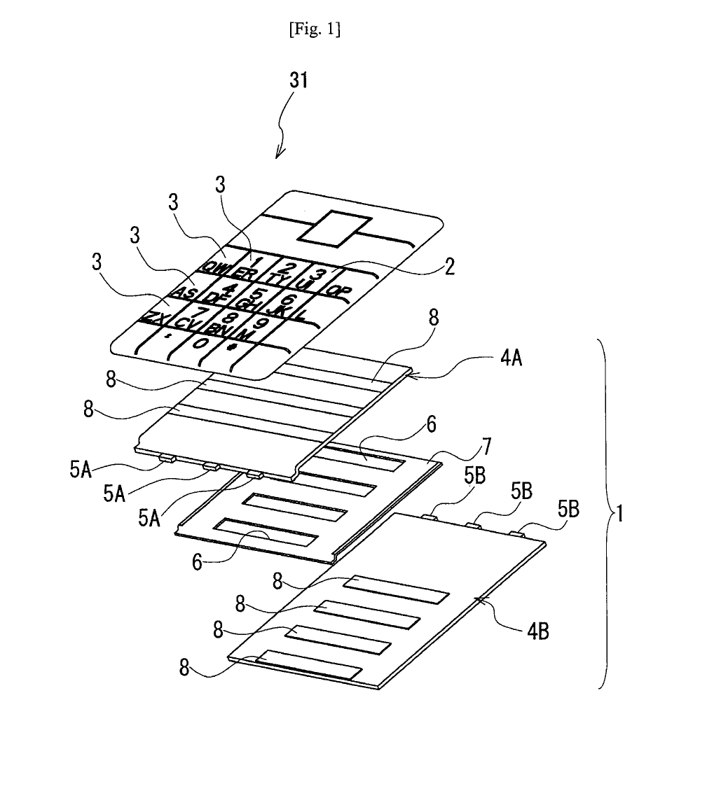

A first embodiment of a lighting device and an electronic device according to the present invention will be explained below with reference to FIGS. 1 to 3. It should be noted that the scale of the figures used in the following explanation is properly changed to show each constituent member in a recognizable size.

A lighting device 1 in this embodiment has, as shown in FIG. 1, an operation panel 31 having a plurality of operation keys 3, two sheet-shaped lightguide members 4A and 4B stacked at a back of the operation panel 31, light sources 5A and 5B arranged to face edges of the two sheet-shaped lightguide members 4A and 4B, respectively, and a sheet-shaped light shield member 7 disposed between the two sheet-shaped lightguide members 4A and 4B. In the illustrated example, the operation panel 31 is a single panel made of a synthetic resin or the like and has a plurality of operation keys formed thereon in a matrix. The operation panel 31 is, however, not limited to the illustrated structure but may have a plurality of individually prepared operation keys mounted thereon.

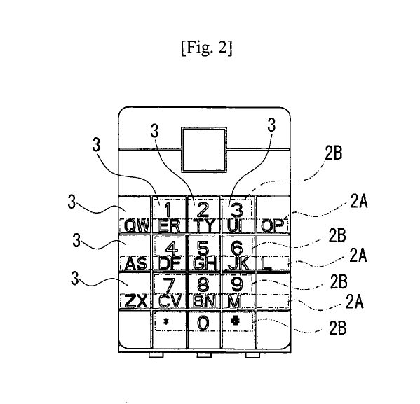

Each operation key 3 is, as shown in FIG. 2, provided with either or both of a number display area 2B having a number displayed thereon and a letter display area 2A having at least one alphabet letter displayed thereon. The display areas 2A and 2B are transparent or semitransparent to transmit light applied from below through the display areas.

The sheet-shaped lightguide members 4A and 4B are flexible lightguide films made of a light-transmitting resin material, for example, which have a high pliability as a whole. The lightguide members 4A and 4B are each designed to receive light from the light sources 5A (5B) provided at one end edge thereof and to guide the light toward the other end edge, and have light-scattering areas 8 serving as light-emitting areas that deflect and emit the guided light toward the letter display areas 2A and the number display areas 2B. The light-scattering areas 8 have the function of upwardly scattering the light guided through the lightguide members 4A and 4B and are formed directly under the letter display areas 2A or number display areas 2B to be illuminated. The light-scattering areas 8 may be formed, for example, by printing a white ink in a large number of dot patterns on the back surfaces of the areas to be the light-scattering areas 8, or forming evaporated silver layers, or providing microscopic optical configurations, e.g. prism configurations, on the front surfaces of the areas.

In the illustrated example, the sheet-shaped lightguide member 4A has the light-scattering areas 8 corresponding to the groups of letter display areas 2A, and the sheet-shaped lightguide member 4B has the light-scattering areas 8 corresponding to the groups of number display areas 2B.

The light sources 5A (5B) are a plurality of white light-emitting diodes (LEDs) disposed along one end edge of the sheet-shaped lightguide member 4A (4B). Each white LED is, for example, a semiconductor light-emitting element mounted on a substrate and sealed with a resin material. The semiconductor light-demitting element is, for example, a blue (wavelength λ: 470 to 490 nm) LED element or an ultraviolet (wavelength λ: less than 470 nm) LED element, which is formed by stacking a plurality of semiconductor layers of a gallium nitride compound semiconductor (e.g. InGaN compound semiconductor) on an insulating substrate, e.g. a sapphire substrate.

The resin material used to seal the semiconductor light-emitting element is formed by adding, for example, a YAG fluorescent substance into a silicone resin as a main component. The YAG fluorescent substance converts blue or ultraviolet light from the semiconductor light-emitting element into yellow light, and white light is produced by color mixing effect. It should be noted that various LED elements in addition to those described above can be used as the white LEDs, for example, a combination of light-emitting elements that emit different colors of light.

The light sources 5A and 5B are selectively controlled according to the following lighting modes: first, the light sources 5A corresponding to the letter display areas 2A are turned on; second, the light sources 5B corresponding to the number display areas 2B are turned on; and third, both the light sources 5A and 5B are simultaneously turned on.

The sheet-shaped light shield member 7 is, for example, a metal sheet, synthetic resin film or metal foil having a light-reflecting function and pliability. In this embodiment, a white synthetic resin film is employed. It should be noted that the sheet-shaped light shield member 7 may be a synthetic resin film provided with an evaporated silver layer or an evaporated aluminum layer, for example, or a black film. The sheet-shaped light shield member 7 has light-transmitting areas 6 formed in the shape of rectangular openings only in areas corresponding to the number display areas 2B. The sheet-shaped light shield member 7 passes light from the sheet-shaped lightguide member 4B only through the light-transmitting areas 6 toward the number display areas 2B and prevents the sheet-shaped lightguide members 4A and 4B from contacting each other, and thus, light is properly directed to the operation panel 31.

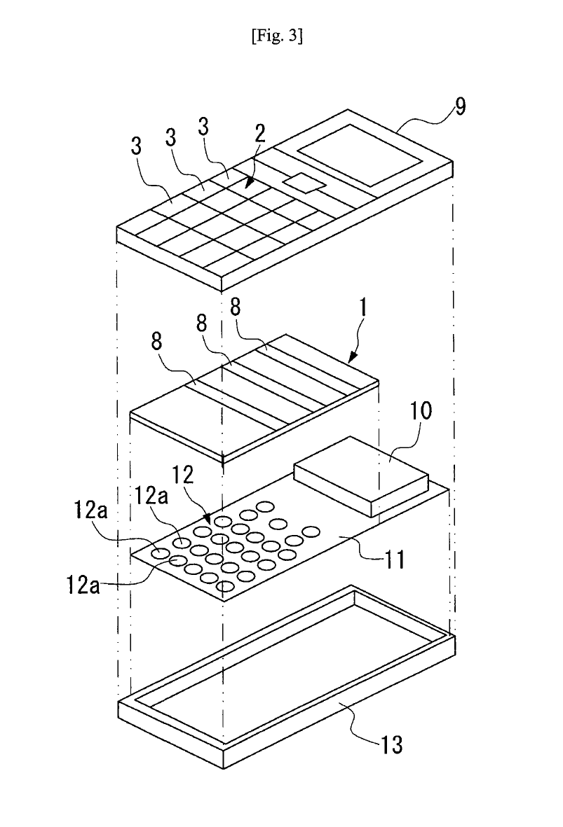

The electronic device in this embodiment is, as shown in FIG. 3, a mobile phone, for example. The electronic device has an upper casing member 9, a lighting device 1, a liquid crystal display panel 10, a substrate 11, a switching part 12, and a lower casing member 13. The upper casing member 9 has an operation panel having a plurality of arrayed operation keys 3 and a display part. The lighting device 1 is disposed underneath the operation panel. The liquid crystal display panel 10 is disposed on the substrate 11 to face the display part. The switching part 12 is provided on the substrate 11 and has switching elements 12a disposed to correspond to the operation keys 3, respectively. The lower casing member 13 accommodates the lighting device 1 and the substrate 11.

The liquid crystal display panel 10 is a transmissive or semitransmissive liquid crystal display panel. In the case of a semitransmissive liquid crystal display panel 10, for example, it has a panel body having a liquid crystal material, e.g. TN liquid crystal or STN liquid crystal, sealed with a sealant in a gap between an upper substrate and a lower substrate, each having a transparent electrode layer, an alignment film and a polarizer. The semitransmissive liquid crystal display panel 10 further has a semitransmitting reflector having both light-transmitting and -reflecting functions, which is provided underneath the panel body. It should be noted that the liquid crystal display panel 10 has a liquid crystal backlight unit (not shown) provided at the back thereof.

The switching elements 12a perform a switching operation by being pressed by the corresponding operation keys 3 through sheet-shaped lightguide members 4A and 4B and a sheet-shaped light shield member 7, which are films of high pliability.

It should be noted that the substrate 11 has mounted thereon electronic components (not shown), such as an IC that controls the mobile phone, and components for communications (not shown) such as an antenna member.

With this electronic device, when it is desired to enter alphabet or other letters through the operation keys 3, control is performed to set the key input mode to the letter input mode and to turn on the light sources 5A for letters, which correspond to the letter display areas 2A, to light up only the letter display areas 2A. Consequently, light entering the sheet-shaped lightguide member 4A for letters, which corresponds to the letter display areas 2A, is deflected upward by the light-scattering areas 8 to illuminate only the letter display areas 2A.

On the other hand, when it is desired to enter numbers through the operation keys 3, control is performed to set the key input setting in the number input mode and to turn on the light sources 5B for numbers, which correspond to the number display areas 2B, to light up only the number display areas 2B. Consequently, light entering the sheet-shaped lightguide member 4B for numbers, which corresponds to the number display areas 2B, is deflected upward by the light-scattering areas 8 to pass through the light-transmitting areas 6 of the sheet-shaped light shield member 7 and through the overlying sheet-shaped lightguide member 4A for letters to illuminate only the number display areas 2B. It should be noted that the system can also be controlled to turn on both the light sources 5A for letters and the light sources 5B for numbers.

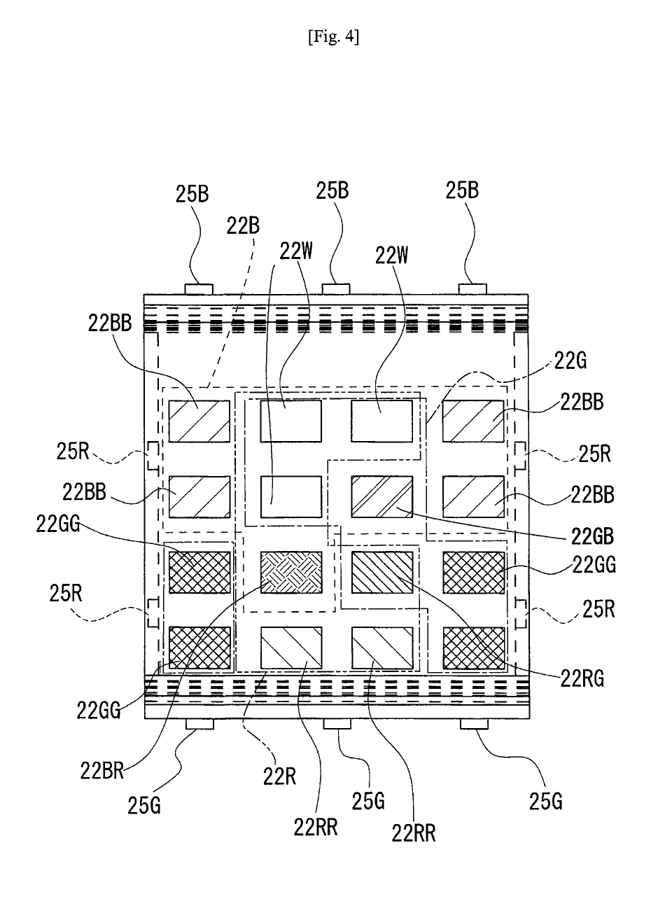

A second embodiment of the present invention will be explained below with reference to FIGS. 4 to 6. In the following explanation of the second embodiment, the same constituent elements as those described in the foregoing first embodiment are denoted by the same reference numerals as used in the first embodiment, and a description thereof is omitted herein.

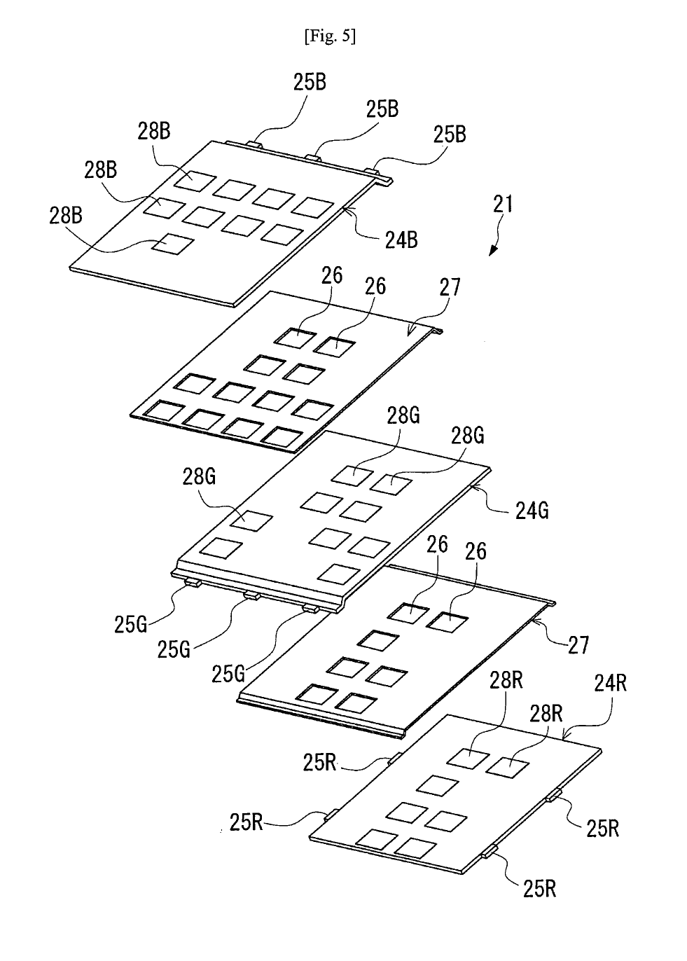

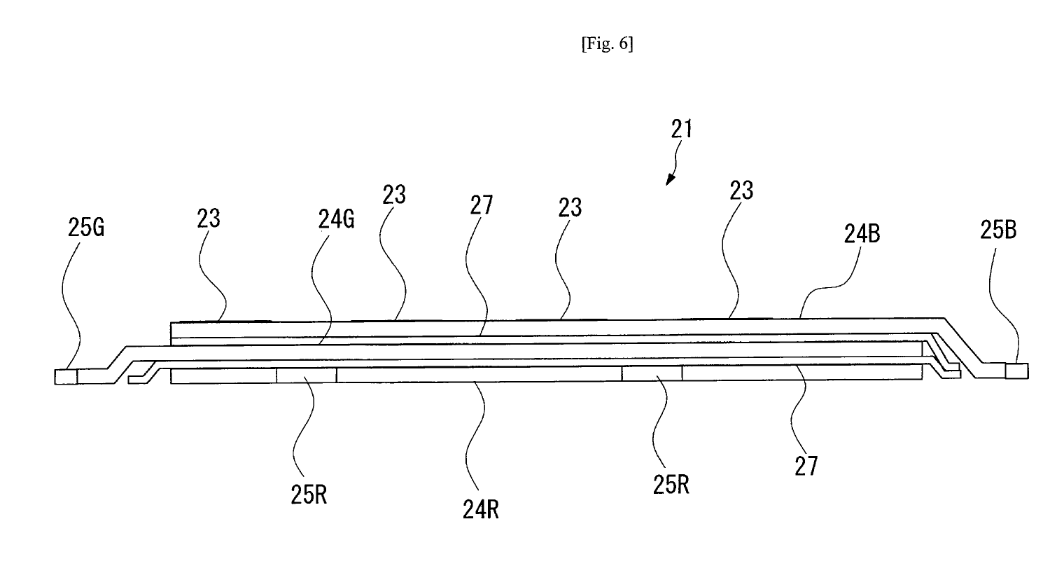

As shown in FIGS. 5 and 6, a lighting device 21 according to the second embodiment comprises a stack of three sheet-shaped lightguide members 24R, 24G and 24B and two sheet-shaped light shield members 27, one of which is provided between the sheet-shaped lightguide members 24R and 24G. The other sheet-shaped light shield member 27 is provided between the sheet-shaped lightguide members 24G and 24B. The respective light sources of colors 25R, 25G, and 25B are arranged to face respective edges of the lightguide members 24R, 24G, and 24B.

The sheet-shaped lightguide members 24R, 24G and 24B have light-deflecting areas (light-scattering areas) 28R, 28G and 28B, respectively, which function in the same way as the sheet-shaped lightguide members in the first embodiment. In this embodiment, the operation keys on the operation panel each have a single display area. The operation keys include a red group 22R of operation keys that are illuminated with light deflected by the light-deflecting areas 28R of the sheet-shaped lightguide member 24R when the red light sources 25R are turned on; a green group 22G of operation keys that are illuminated with light deflected by the light-deflecting areas 28G of the sheet-shaped lightguide member 24G when the green light sources 25G are turned on; and a blue group 22B of operation keys that are illuminated with light deflected by the light-deflecting areas 28B of the sheet-shaped lightguide member 24B when the blue light sources 25B are turned on. Accordingly, when the red light sources 25R, the green light sources 25G and the blue light sources 25B are turned on simultaneously, the operation keys on the operation panel present display areas 22RR illuminated with single-color light of red; display areas 22GG illuminated with single-color light of green; display areas 22BB illuminated with single-color light of blue; a display area 22RG illuminated with mixed-color light of red and green; a display area 22GB illuminated with mixed-color light of green and blue; a display area 22BR illuminated with mixed-color light of blue and red; and display areas 22W illuminated with mixed-color light of red, green and blue.

The red light sources 25R have red LEDs. The green light sources 25G have greed LEDs. The blue light sources 25B have blue LEDs.

The green light sources 25G and the blue light sources 25B are arranged along the mutually opposite end edges of the sheet-shaped lightguide members 24G and 24B. The red light sources 25R are arranged along both side end edges of the sheet-shaped lightguide member 24R.

The lower sheet-shaped light shield member 27 has light-transmitting areas 26 for passing red light from the lightguide member 24R to the operation keys in the red group 22R. The upper sheet-shaped light shield member 27 has light-transmitting areas 26 for passing green light directed to the operation keys in the green group 22G and/ or red light having passed through the light-transmitting areas 26 of the lower sheet-shaped light shield member 27.

The lightguide member 24G transmits upwardly red light having passed through the light-transmitting areas 26 of the lower light shield member 27. Red light passing through the light-deflecting areas 28G of the lightguide member 24G mixes with green light and travels toward the operation keys. Red light passing through areas other than the light-deflecting areas 28G travels toward the operation keys as it is.

The lightguide member 24B transmits upwardly red light and green light having passed through the light-transmitting areas 26 of the upper light shield member 27. Red light passing through the light-deflecting areas 28G of the lightguide member 24G and green light mix with blue light and travel toward the operation keys. Red light passing through areas other than the light-deflecting areas 28G travels toward the operation keys as it is.

The lower sheet-shaped light shield member 27 is folded downward at end-edge sides where the light sources 25R of the underlying sheet-shaped lightguide member 24R are not present to prevent light other than light from the red light sources 25R from entering through the end edges of the lower sheet-shaped light shield member. Similarly, the upper sheet-shaped light shield member 27 is folded downward at an end edge side opposite to the end edge side where the light sources 25G of the underlying sheet-shaped lightguide member 24G are disposed.

It should be noted that the present invention is not necessarily limited to the foregoing embodiments but can be modified in a variety of ways without departing from the scope of the present invention.

For example, the sheet-shaped light shield members in the foregoing embodiments have light-transmitting areas defined by cut openings. However, each sheet-shaped light shield member may be made of a transparent material, e.g. a transparent film, as a whole and painted white or silver at areas thereof other than light-transmitting areas to form light-shielding areas.

Although the first embodiment employs white LEDs as light sources, red, green and blue LEDs may be used to illuminate the operation keys with various colors of light. The light sources may be LEDs each having red, green and blue LED elements mounted in one package. Alternatively, LEDs that emit mutually different colors of light may be disposed at at least one edge of one sheet-shaped lightguide member as light sources. In these cases, the operation keys can be illuminated with various colors of light by controlling the electric current applied to each LED.

The lighting device in the first embodiment may be arranged as follows. The above-described white LEDs are used as light sources disposed for one sheet-shaped lightguide member, and red, green and blue LEDs are used as light sources for the other sheet-shaped lightguide member.

Although in the foregoing embodiments the present invention is applied to a mobile phone, the present invention is also applicable to other various electronic devices, e.g. personal digital assistants (PDAs), mobile personal computers (PCs), and mobile game machines.

What is claimed is:

1. A lighting device that illuminates an operation panel from a back thereof, the operation panel comprising a plurality of operation keys arranged in a plane, the operation keys each having at least one display area capable of transmitting light, the display areas on the operation panel being divided into a plurality of groups, each having at least one display area, the lighting device comprising:
at least two sheet-shaped lightguide members corresponding to the plurality of groups, respectively, the sheet-shaped lightguide members being stacked at a back of the operation panel; and
at least one light source provided to face at least one edge of each of the sheet-shaped lightguide members to emit light through the edge of the each sheet-shaped lightguide member that guides the light;
the each sheet-shaped lightguide member having at least one light-emitting area that deflects and emits the guided light toward the at least one display area of the corresponding group.

2. The lighting device of claim 1, wherein the at least one light-emitting area of the each sheet-shaped lightguide member is provided at a position that faces the at least one display area of the corresponding group in a stacking direction of the sheet-shaped lightguide members.

3. The lighting device of claim 1, wherein at least two of the groups share at least one display area with each other.

4. The lighting device of claim 2, wherein at least two of the groups share at least one display area with each other.

5. The lighting device of claim 1, further comprising:
at least one sheet-shaped light shield member each disposed between mutually adjacent ones of the sheet-shaped lightguide members, the each sheet-shaped light shield member having at least one light-transmitting area that is a passage of light toward the at least one display area, the light being emitted from the light-emitting area of any of the sheet-shaped lightguide members that are disposed more away from the operation panel than the each sheet-shaped light shield member.

6. The lighting device of claim 2, further comprising:
at least one sheet-shaped light shield member each disposed between mutually adjacent ones of the each sheet-shaped lightguide members, the sheet-shaped light shield member having at least one light-transmitting area that is a passage of light toward the at least one display area, the light being emitted from the light-deflecting area of any of the sheet-shaped lightguide members that are disposed more away from the operation panel than the each sheet-shaped light shield member.

7. The lighting device of claim 3, further comprising:
a sheet-shaped light shield member each disposed between mutually adjacent ones of the sheet-shaped lightguide members, the each sheet-shaped light shield member having at least one light-transmitting area that is a passage of light toward the at least one display area, the light being emitted from the light-deflecting area of any of the sheet-shaped lightguide members that are disposed more away from the operation panel than the each sheet-shaped light shield member.

8. The lighting device of claim 4, further comprising:
at least one sheet-shaped light shield member each disposed between mutually adjacent ones of the sheet-shaped lightguide members, the each sheet-shaped light shield member having at least one light-transmitting area that is a passage of light toward the at least one display area, the light being emitted from the light-deflecting area of any of the sheet-shaped lightguide members that are more away from the operation panel than the each sheet-shaped light shield member.

9. The lighting device of claim 5, wherein the light-emitting area deflects the guided light by reflection and scattering.

10. The lighting device of claim 6, wherein the light-emitting area deflects the guided light by reflection and scattering.

11. The lighting device of claim 7, wherein the light-emitting area deflects the guided light by reflection and scattering.

12. The lighting device of claim 5, wherein the plurality of light sources have different colors of emission for each of the sheet-shaped lightguide members and the respective light sources face the respective lightguide members at at least one edge of the each lightguide member. 13. The lighting device of claim 6, wherein the plurality of light sources have different colors of emission for each of the sheet-shaped lightguide members and the respective light sources face the respective lightguide members at at least one edge of the each lightguide member.

14. The lighting device of claim 7, wherein the plurality of light sources have different colors of emission for each of the sheet-shaped lightguide members and the respective light sources face the respective lightguide members at at least one edge of the each lightguide member.

15. The lighting device of claim 8, wherein the plurality of light sources have different colors of emission for each of the sheet-shaped lightguide members and the respective light sources face the respective lightguide members at at least one edge of the each lightguide member.

16. The lighting device of claim 5, wherein the plurality of light sources include a red light source, a green light source, and a blue light source.

17. The lighting device of claim 6, wherein the plurality of light sources include a red light source, a green light source, and a blue light source.

18. The lighting device of claim 7, wherein the plurality of light sources include a red light source, a green light source, and a blue light source.

19. The lighting device of claim 8, wherein the plurality of light sources include a red light source, a green light source, and a blue light source.

20. An electronic device comprising:
an operation panel comprising a plurality of operation keys arranged thereon, the operation keys each having at least one display area to transmit light, the display areas on the operation panel being divided into a plurality of groups;
the lighting device of claim 1; and
a switching part disposed at a side of the stacked sheet-shaped lightguide members of the lighting device that is opposite to the operation panel, the switching part having switching elements disposed to correspond to the operation keys, respectively.
